(19) United States
(12) Patent Application Publication
(10) Pub. No.: US 2003/0192709 A1
(43) Pub. Date: Oct. 16, 2003

(54) Holding stick for soil treatment elements to be actuated by rotation

(76) Inventor: Hartwig Sandholzer, Buchenberg (DE)

Correspondence Address: COLLARD & ROE, P.C., 1077 Northen Boulevard, Roslyn, NY, 11576, US

(21) Appl. No.: 10/412,459

(22) Filed: Apr. 11, 2003

(30) Foreign Application Priority Data
Apr. 15, 2002 (DE) 202 05 832.8

(51) Int. Cl. A01B 79/00

(52) U.S. Cl. 172/1

(57) ABSTRACT

A holding stick for soil treatment elements to be actuated by rotation is provided, comprising a handle that is arranged transversely at the upper end of the stick and can be locked into position and rotated in stages relative to the stick. The handle can be adjusted relative to the stick within an axial limit by means of a pivot that is arranged in the center of the handle and engages in the hollow upper end of the stick. Oppositely directed engaging saw tooth-like helical gearings are arranged at the pivot and the stick, enclosing the pivot and the stick like a ring. Said helical gearings form a ratchet, and the treatment element located at the lower end of the stick can be actuated in the rotation direction by means of said ratchet.

### BACKGROUND OF THE INVENTION

1. Field of the Invention

The invention relates to a holding stick for soil treatment elements to be actuated by rotation, such as soil drills, soil loosening devices, plant hole punchers, etc.

2. Description of the Prior Art

Holding sticks of this type are comprised of a handle that is arranged transversely at the upper end of the stick, which can be locked in stages and rotated relative to the stick, especially a double-armed handle. Holding sticks of this type are known, for example, from the German utility model 200 12 244 U1, the object of which is a hand-held device with a ratchet handle used for the treatment of yard soil, having fork-like claws and/or teeth that are arranged at the lower end of the stick as soil treatment elements to loosen up the soil by rotation. For the sake of completeness, reference is also made, for example, to the U.S. Pat. Nos. 2,809,067, 3,129,771 and 4,905,768 with respect to soil treatment elements of this type.

With respect to the aforementioned German utility model 200 12 244, a spring-loaded so-called ratchet freewheel mechanism is built into a cross tube that forms a double-armed handle. The actual ratchet member is in active connection with the roughly saw tooth-bordered upper end of the device stick so that the handle can be freely rotated backward relative to the stick and drives the stick when turned counter-clockwise. Although this device may function, it is disadvantageous in that it requires a spring that is prone to breaking, which holds a ratchet catch built into the handle in engagement against the end of the device stick that has a ratchet gearing. The tube length that forms the handle is appropriately weakened by the engagement of the end of the stick and the tube length that forms the handle, and is therefore prone to bending and breaking. Furthermore, it must be ensured that the double-armed handle is rotationally affixed and guided on the end of the stick. However, the conditions for attaching and/or guiding of the handle tube length are most unfavorable because said handle tube length has to be rotated back and forth continually relative to the stick during use.

### SUMMARY OF THE INVENTION

Thus, one object of the invention is to provide an improved holding stick for soil treatment elements such that even with a ratchet principle, a spring is not required, the handling of the holding stick is well guided under load relative to the upper end of the holding stick, and the ratchet elements can be actuated in axial direction of the holding stick.

It is a further object of the invention to develop the holding stick in such a way that an easy plug-connection can be achieved between the handle of the holding stick and the holding stick, and the handle can be simply locked into position in the holding stick with a specific axial play.

Furthermore, it is an object of the invention to develop the ratchet elements as a means that is exchangeable and can be attached to the handle and the holding stick in a simple way.

According to the present invention, a holding stick is provided having a handle that is arranged transverse at the upper end of the stick and can be locked into position and rotated relative to the stick, with the improvement in accordance with the invention being that the handle can be adjusted within an axial limit relative to the stick by means of a pivot that engages in the hollow upper end of the stick and is arranged in the center of the handle, and that oppositely directed, saw tooth-like engaging helical gearings which enclose the pivot and stick like a ring are arranged at the pivot and the stick.

In this context, “adjustable relative to the stick within an axial limit” means a measurement by which the two helical gears must be disengaged in order to be able to rotate back the handle. Said disengagement occurs automatically when the handle is rotated back because in doing so, the helical gearing on the handle side is supported by the helical gearing on the stick side and elevates the teeth accordingly when sliding upward on the slanted planes of the gearings. Advantageously, this does not require a spring because the upper gearing immediately engages again with the gearing on the handle side after it was rotated backward, and the stick is then directly driven again by rotation when the handle is rotated forward. Aside from the fact that this process does not require a spring, the double-armed handle is also in contact with the stick through a sturdy axial bearing, which will be explained in greater detail.

Advantageous further developments, which are aimed in particular at a simple and cost-efficient production, are that on the one hand, the pivot is arranged in a tube length that is arranged at the handle and projects from said tube length engaging with its projecting end piece into the stick formed of a corresponding tube length, and furthermore in that the helical gearing that encloses the pivot and the stick form the faces of two sleeves of which one is attached at the tube length of the handle and the other is attached adjacently at the stick.

### BRIEF DESCRIPTION OF THE DRAWINGS

The above and other features of the invention will be better understood from the following description of the preferred embodiments illustrated in the accompanying drawings, wherein

FIG. 1 shows a view of the holding stick with a soil treatment device indicated only schematically;

FIG. 2 shows a partial section and a view of a special embodiment of the handle as upper part of the holding stick;

FIG. 3 shows a partial section and a view of the upper end of the holding stick into which the handle can be plugged in accordance with FIG. 3;

FIG. 4 shows a schematic top view of the ratchet element;

FIG. 5 shows a section of a special embodiment of the ratchet elements, and

FIG. 6 shows a partial section and a view of the handle as it is inserted into the holding stick and locked into position in the preferred embodiment.

### DESCRIPTION OF THE PREFERRED EMBODIMENTS

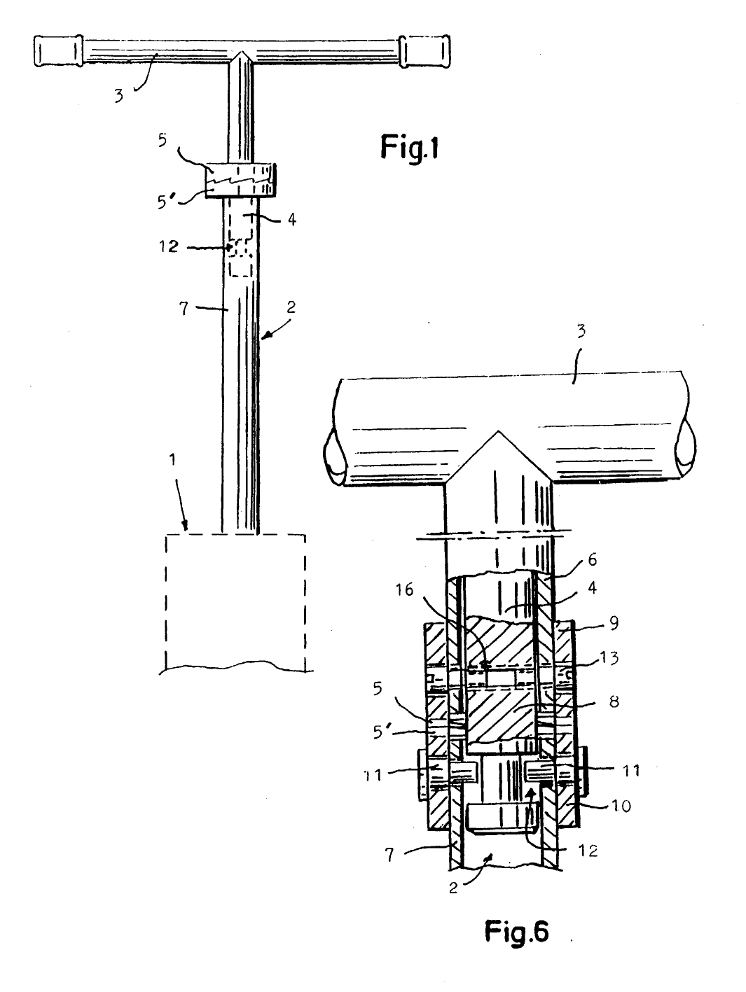

The holding stick is comprised of a double-armed handle 3 that is arranged transversely at the upper end of the stick 2 and can be locked into position and rotated in stages relative to the stick 2. The soil treatment element 1 is indicated only schematically and in dashed lines in FIG. 1. FIG. 1 furthermore emphasizes the essential structural principle in accordance with the invention in that the handle 3 can be adjusted relative to the stick 2 within an axial limit by means of a pivot 4 that is arranged in the center of the handle and engages in the hollow upper end of the stick 2, and that oppositely directed engaging saw tooth-like helical gearings 5, 5′ are arranged at the pivot 4 and the stick 2, which enclose the pivot 4 and the stick like a ring. When the handle 3 is rotated counter-clockwise, the upper gearing 5 therefore ratchets over the lower gearing 5′ with slight axial lift and said lower gearing 5′ is then driven clockwise when the direction of rotation changes and carries along the treatment element 1 at the lower end of the stick 2. The illustration of the holding stick in FIG. 1 thus represents the simplest embodiment of the invention because the pivot 4 is itself a direct integral component of the handle 3.

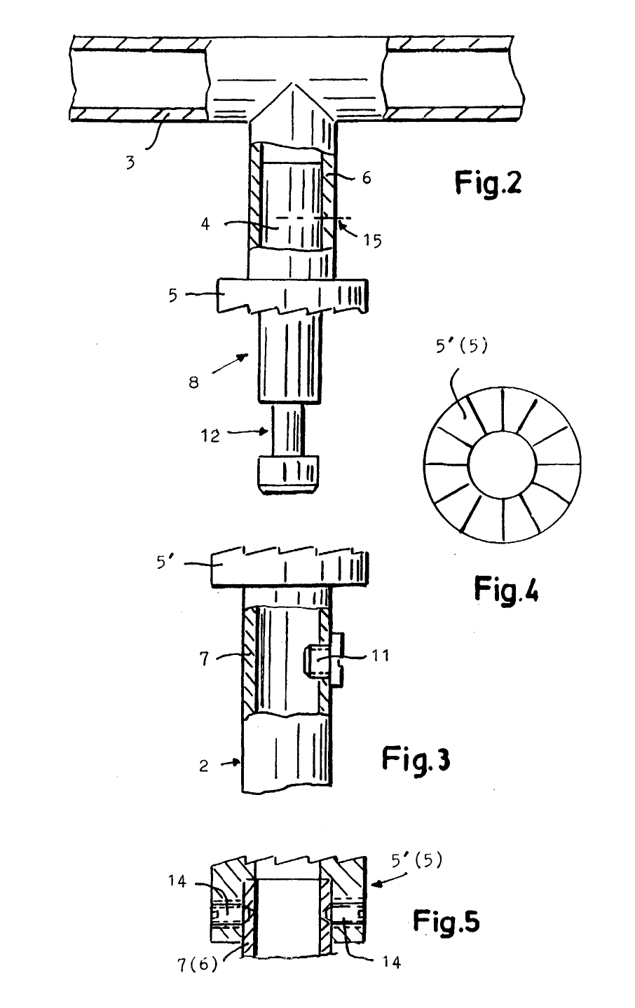

In the illustration in accordance with FIG. 2, for example, the pivot 4 and the element having the upper helical gearing 5 are formed of one piece. The end 8 of the pivot 4, which projects from below the helical gearing 5, has a continuous groove 12 into which at least one screw 11 (see FIG. 3) engages as axial an adjustment stop when the end 8 is plugged into the tube length 7 of the stick. Said screw 11, of which there is at least one, also holds together the stick 2 and the handle 3, but allows an axial play around the height of the helical gearing 5, 5′. Aside from the fact that the pivot 4, as already mentioned, is attached directly at the handle 3 in the sense of FIG. 1 and could be welded to the same, for example, the handle 3 has in said embodiment a tube length into which the pivot 4 can be plugged and affixed therein to be exchangeable at 15, for example by means of a screw not shown here.

The elements having the helical gearings 5, 5′, of which one is shown in FIG. 4 in top view, can be welded to the tube length 6 and the tube length 7 at the stick 2, or they can be affixed with adjusting bolts 12 in the case of a plug-in embodiment in the sense of FIG. 5.

The preferred embodiment, however, is the embodiment in accordance with FIG. 6. In said embodiment, the pivot 4 is also located in a tube length 6 arranged at the handle 3 and projects from the bottom of said tube length. The projecting end piece 8 of the pivot engages into the stick 2 formed by the corresponding tube length 7, and furthermore, the helical gearings 5, 5′ that enclose the pivot 4 and the stick 2 are arranged at oppositely directed faces of two sleeves 9, 10, of which the one sleeve 9 is attached to the tube length 6 of the handle 3 and the other sleeve 10 is attached adjacently at the tube length 7 forming the stick 2.

As it is easily conceivable, said development leads to a very suitable and cost-efficient production especially of the helical gearings 5, 5′, which can be attached without problem at the face side of the sleeves 9, 10 and furthermore can also be hardened in this way without any problems. In addition, the sleeves 9, 10 can be exchanged in case of wear and ear of the helical gearings 5, 5′.

Furthermore, it is conceivable to exchange a set of sleeves and/or a pair of sleeves for another one that has helical gearings oriented in the opposite direction to make it easier for left-handed users, who would normally tend to rotate the handle counter-clockwise under load, to rotate the handle 3.

With respect to the pivot 4 of the handle 3 for the axial adjustment limit relative to the stick 2, said pivot can be provided with a continuous grove 12 (see FIG. 2) as mentioned above, to engage at least one adjustment stop 11, with both of said adjustment stops 11 advantageously being useable simultaneously as affixing elements to affix the sleeve 10 at the tube length 7 that forms the stick 2. As shown in FIG. 6, the upper sleeve 9 is affixed at the tube length 6 with screws 13, which can be screwed into corresponding threaded holes 16 in the pivot 4.

Finally, it should be pointed out that the pivot 4 can also be arranged oppositely, i.e., it can be arranged firmly in the tube length 7 of the stick 2 and engage with its end that then projects upward into the tube length 6 at the handle 3. This does not change anything with respect to the structural- and function principle as described above.

1. A holding stick for soil treatment elements (1) to be actuated by rotation, comprising a handle (3) that is arranged transversely at the upper end of the stick (2) and can be locked into position and rotated in stages relative to the stick (2), with the improvement being that the handle (3) can be adjusted relative to the stick (2) within an axial limit by means of a pivot (4) that is arranged in the center of the handle and engages in the hollow upper end of the stick (2), and that oppositely directed engaging saw tooth-like helical gearings (5, 5′) are arranged at the pivot (4) and the stick (2), which enclose the pivot (4) and the stick like a ring.

2. The holding stick in accordance with calm 1, with the pivot (4) being arranged in a tube length (6) arranged at the handle (3) and the pivot (4) projecting from the tube length (6) and engaging with its projecting end piece (8) into a stick (2) formed by a corresponding tube length (7).

3. The holding stick in accordance with claim 2, with the helical gearings (5, 5′) enclosing the pivot (4) and the stick (2) forming the faces of two sleeves (9, 10), of which one sleeve (9) is attached at the tube length (6) of the handle (3) and the other sleeve (10) is attached adjacently at the stick (2)

4. The holding stick in accordance with claim 1, with the pivot (4) having a continuous groove (12) for the axially limited adjustment relative to the stick (2) and for the engagement of at least one adjustment stop (11).

5. The holding stick in accordance with claim 4, with the sleeve (10) being affixed at the tube length (7) of the stick (2) with at least one adjustment stop (11).

6. The holding stick in accordance with claim 4, with the sleeve (9) being affixed at the tube length (6) by means of at least one screw (13) that can be screwed into the pivot and reaches through the tube length (6).

7. The holding stick in accordance with claim 3, with both sleeves (9, 10) being formed identically.

8. The holding stick in accordance with claim 1, with the helical gearings (5, 5′) being hardened.
